(19) United States
(12) Patent Application Publication
(10) Pub. No.: US 2007/0027599 A1
(43) Pub. Date: Feb. 1, 2007

(54) Headrest apparatus for vehicle

(75) Inventors: Morio Sakai, Toyota-shi (JP); Koichi Hirota, Takahama-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/486,050

(22) Filed: Jul. 14, 2006

(30) Foreign Application Priority Data
Jul. 26, 2005 (JP) 2005-216438

(51) Int. Cl. G06F 17/00

(52) U.S. Cl. 701/49; 297/216.12; 297/408

(57) ABSTRACT

A headrest apparatus for a vehicle includes a headrest rear portion, a headrest front portion being movable between a fully closed position and a fully open position, a driving means for moving the headrest front portion, a capacitance sensor provided at the headrest front portion for detecting a change in capacitance, and a controlling means for controlling the driving means and comparing an amount of change in capacitance detected by the capacitance sensor to a predetermined threshold value when the headrest front portion moves towards the fully open position. The controlling means determines that the headrest front portion is positioned close to a head of an occupant when the amount of change in capacitance exceeds the threshold value. Further, the controlling means detects a capacitance change per unit moving distance of the capacitance sensor at a predetermined timing and changes the threshold value based on the detected result.

### CROSS REFERENCE TO RELATED APPLICATIONS

This application is based on and claims priority under 35 U.S.C. § 119 to Japanese Patent Application No. 2005-216438, filed on Jul. 26, 2005, the entire content of which is incorporated herein by reference.

### FIELD OF THE INVENTION

This invention generally relates to a headrest apparatus for a vehicle.

### BACKGROUND

A known seat for a vehicle is equipped with a mechanism for moving a headrest in a vehicle's forward direction for the purposes of protecting the head of a seated occupant in the event of a rear end collision. Such vehicle seat is disclosed in JP2000-211410A and JP2003-54343A.

When an impact is applied to a vehicle from the rear, an upper body of a seated occupant is restrained onto a seatback by means of a seatbelt. However, the head of the occupant that is not restrained may be hurled forward and then be shifted rearward because of a reaction force. At that time, the neck of the occupant may receive the impact. Then, in this case, the headrest is brought to move in a vehicle's forward direction relative to the seatback for the purpose of protecting the head of the seated occupant, thereby reducing the impact applied to the neck of the occupant.

In the cases where the headrest moves in the vehicle's forward direction, a sensor for detecting the head of an occupant is required so as to stop the headrest in response to a position of the occupant's head. For example, as shown in FIG. 9A, a capacitance sensor 102 for detecting a capacitance change caused by an approach of a detected object is provided at a front surface (i.e. a surface facing the head of an occupant) of a headrest 101. The approach of the detected object can be determined on the basis of a change in capacitance detected by the capacitance sensor 102. As shown in FIG. 9B, when the headrest 101 approaches the head of an occupant, a capacitance value detected by the capacitance sensor 102 becomes large. Accordingly, it is determined that the headrest 101 is positioned close to the head of the occupant.

In this case, the approach of the headrest 101 to the head of the occupant can be detected on the basis of an absolute value of capacitance value. However, since the capacitance is easily affected by temperature and humidity, an error in detection may be caused. For example, as shown in FIG. 10, characteristics of the capacitance value and a distance from the head of the occupant (for example, a distance La and a distance Lb shown in FIGS. 9A and 9B) may vary depending on a dielectric constant of a space defined between the capacitance sensor 102 and the head of an occupant.

Then, if the approach of the capacitance sensor 102 to the head of the occupant is detected on the basis of an amount of change in capacitance value, the effect of temperature and humidity can be reduced. The amount of change in capacitance becomes large when the capacitance sensor 102 approaches the head of the occupant. Thus, when a predetermined threshold value and the amount of change in capacitance are compared to each other and it is found that the amount of change in capacitance exceeds the threshold value, it is then determined that the headrest 101 is positioned close to the head of the occupant. Accordingly, the headrest 101 can be stopped in response to a position of the head of the occupant.

However, in the cases where the approach of the occupant's head is detected by the amount of change in capacitance, setting of only one threshold value as mentioned above may cause an error in detection of the approach of the headrest 101 to the occupant's head since the amount of change in capacitance relative to a moving distance of the headrest 101 varies depending on a capacitance state of the capacitance sensor 102.

As shown in FIG. 10, the amount of change in capacitance per unit moving distance in a position of the distance Lb is large (i.e. an amount of change ΔC2) when the dielectric constant of the space defined between the headrest 101 and the head of the occupant is high. On the other hand, the amount of change in capacitance per unit moving distance in a position of the distance Lb is small (i.e. an amount of change ΔC1) when the dielectric constant of the space defined between the headrest 101 and the head of the occupant is low. This is because the capacitance value of the capacitance sensor 102 is proportional to the dielectric constant of the space between the headrest 101 and the head of the occupant.

Therefore, if the threshold value is specified on the basis of low dielectric constant (at the time the amount of change is ΔC1), for example, it may be determined that the capacitance sensor 14 is positioned close to the head of the occupant before a space, precisely, a distance, between the headrest 101 and the head of the occupant reaches the distance Lb in the case of high dielectric constant. Accordingly, if only one threshold value is specified for detecting the approach of the headrest 101 to the head of the occupant, a detected position of the headrest 101 may not be precise, which may cause a wrong detection that the headrest 101 is positioned close to the head though in fact the headrest 101 is positioned away from the head.

Thus, a need exists for a headrest apparatus for a vehicle that can appropriately detect an approach of a headrest front portion to the head of an occupant.

### SUMMARY OF THE INVENTION

According to an aspect of the present invention, a headrest apparatus for a vehicle includes a headrest rear portion supported by a seatback, a headrest front portion being movable between a fully closed position in which the headrest front portion is closed to the headrest rear portion, and a fully open position in which the headrest front portion is away from the headrest rear portion, a driving means for moving the headrest front portion, a capacitance sensor provided at the headrest front portion for detecting a change in capacitance that is caused in response to a distance from a detected object, and a controlling means for controlling the driving means and comparing an amount of change in capacitance detected by the capacitance sensor to a predetermined threshold value when the headrest front portion moves towards the fully open position. The controlling means determines that the headrest front portion is positioned close to a head of an occupant when the amount of change in capacitance exceeds the threshold value. In addition, the controlling means detects a capacitance change per unit moving distance of the capacitance sensor at a predetermined timing and changes the threshold value based on the detected result.

### BRIEF DESCRIPTION OF THE DRAWINGS

The foregoing and additional features and characteristics of the present invention will become more apparent from the following detailed description considered with reference to the accompanying drawings, wherein:

FIG. 1 is a side view of a seat for a vehicle;

FIGS. 2A and 2B are side views for explaining an operation of a headrest front portion;

FIG. 3 is a block diagram of an electric structure of a headrest apparatus for a vehicle;

FIG. 4 is a data table for showing threshold values in response to a capacitance state of a capacitance sensor and a driving voltage of a motor;

FIGS. 5A and 5B are flowcharts of a process performed by the headrest apparatus for a vehicle;

FIG. 6 is a block diagram for showing an electric structure of the headrest apparatus for a vehicle;

FIG. 7 is a data table for showing threshold values in response to the capacitance state of the capacitance sensor and a moving speed of the headrest front portion;

FIG. 8 is a flowchart for explaining a process performed by the headrest apparatus for a vehicle;

FIGS. 9A and 9B are side views for explaining an operation of a headrest front portion according to a headrest apparatus for a vehicle; and

FIG. 10 is a characteristic chart of a distance between a detected object of a conventional capacitance sensor and a capacitance value.

### DETAILED DESCRIPTION

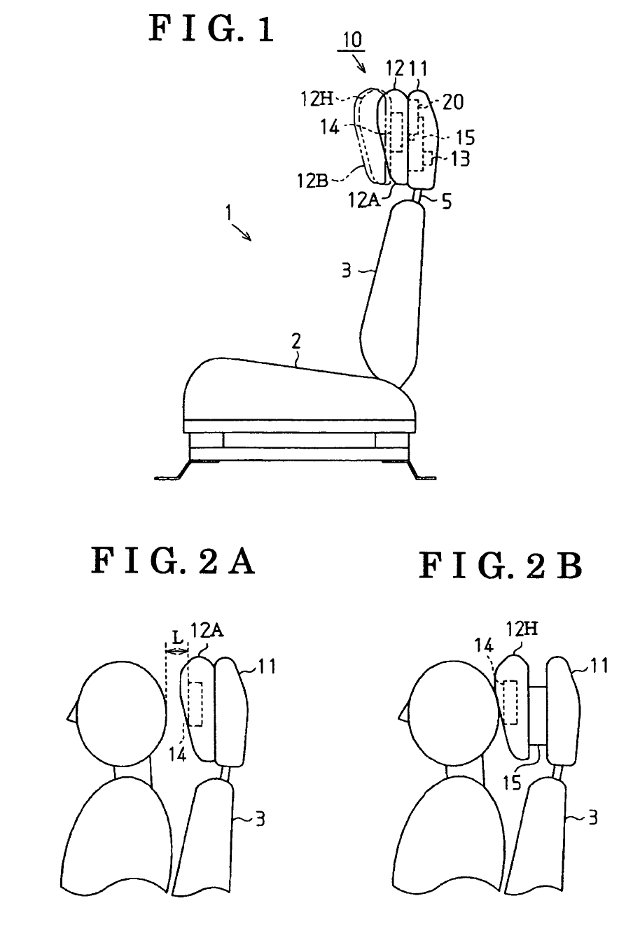

A first embodiment is explained with reference to the attached drawings. FIG. 1 is a side view of a vehicle seat 1 to which a headrest for a vehicle according to the first embodiment is applied. The vehicle seat 1 is arranged on a passenger seat side of a vehicle. As shown in FIG. 1, the vehicle seat 1 includes a seat cushion 2, a seatback 3 supported by the seat cushion 2 so as to be tiltable relative to the seat cushion 2, and a headrest apparatus 10 for a vehicle.

The headrest apparatus 10 includes a headrest rear portion 11, a headrest front portion 12, a motor 13 serving as a driving means for moving the headrest front portion 12, a capacitance sensor 14, and an ECU (Electronic Control Unit) 20 serving as a controlling means for controlling the driving of the motor 13.

As shown in FIG. 1, the headrest rear portion 11 is supported by a headrest stay 5 provided on a top end portion of the seatback 3. The headrest front portion 12 is movable between a fully closed position 12A shown by a solid line in FIG. 1 in which the headrest front portion 12 is close to the headrest rear portion 11, and a fully open position 12B shown by a chain double-dashed line in FIG. 1 in which the headrest front portion 12 is away from the headrest rear portion 11. When a vehicle is in a normal running state, the headrest front portion 12 is in the fully closed position 12A.

A driving mechanism 15 is arranged between the headrest rear portion 11 and the headrest front portion 12. The driving mechanism 15 is elongated or retracted by the driving of the motor 13 so that the headrest front portion 12 is able to move close to or move away from the headrest rear portion 11.

The capacitance sensor 14 provided at the headrest front portion 12 has a known structure of detecting a change in capacitance, which is caused in response to a distance from a detected object. According to the capacitance sensor 14, a detected capacitance value increases as the detected object such as the head of an occupant approaches the capacitance sensor 14.

The ECU 20 controls the motor 13 in such a manner that the headrest front portion 12 moves from the fully closed position 12A towards the fully open position 12B in the event of a rear end collision and then returns to the original fully closed position 12A.

In addition, the ECU 20 detects on the basis of a detected signal from the capacitance sensor 14 that the capacitance sensor 14 is positioned close to the head of an occupant. Precisely, when the headrest front portion 12 moves from the fully closed position 12A towards the fully open position 12B as shown in FIGS. 2A and 2B, the ECU 20 compares an amount of change in capacitance detected by the capacitance sensor 14 and a predetermined threshold value. In the cases where the detected amount of change is larger than the threshold value, it is determined that the headrest front portion 12 is positioned close to the head of an occupant. The ECU 20 then brings the headrest front portion 12 to stop at a stop position 12H shown in FIG. 2B. If the approach of the head of an occupant is not detected, the ECU 20 brings the headrest front portion 12 to move to the fully open position 12B.

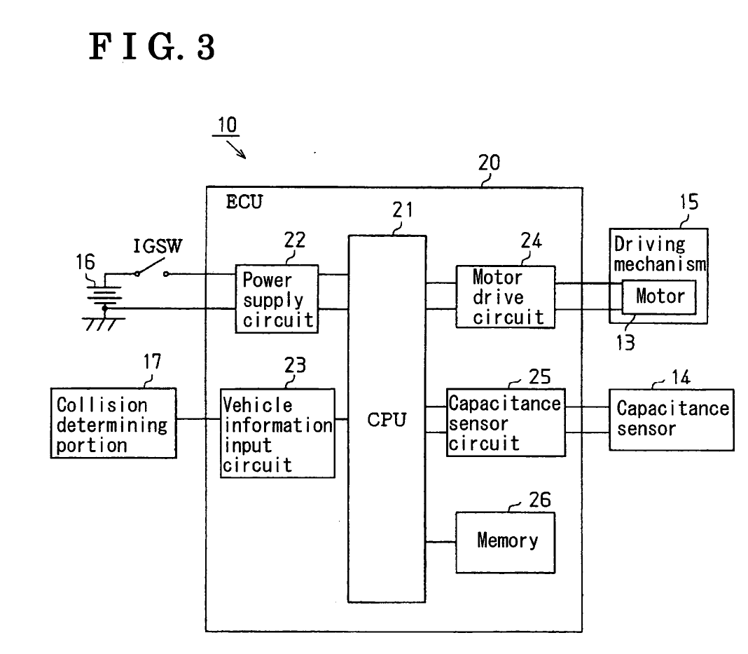

Next, an electrical structure of the headrest apparatus 10 for a vehicle is explained below. As shown in FIG. 3, the headrest apparatus 10 includes the ECU 20, the motor 13 connected to the ECU 20, the capacitance sensor 14, a power supply unit 16, a collision determining portion 17, and the like.

The ECU 20 includes a CPU 21, a power supply circuit 22 connected to the CPU 21, a vehicle information input circuit 23, a motor drive circuit 24, a capacitance sensor circuit 25, a memory 26, and the like.

The CPU 21 is connected to the power supply unit 16 by means of an ignition switch (IGSW). When the ignition switch is turned on, power is supplied from the power supply unit 16 through the power supply circuit 22.

Further, the CPU 21 inputs a vehicle information such as a vehicle approach from the rear from the collision determining portion 17 through the vehicle information input circuit 23. The collision determining portion 17 is connected to a radar (not shown) provided at a bumper on a rear portion of a vehicle. The collision determining portion 17 inputs a signal from the radar to comprehensively evaluate a relative speed and a distance to a following vehicle, and a speed of a present vehicle. The CPU 21 determines whether or not the following vehicle has collided against the present vehicle, or whether or not the following vehicle is about to collide against the present vehicle. Then, that determination result is output to the vehicle information input circuit 23. The CPU 21 is connected to the motor 13 by means of the motor drive circuit 24 so as to drive the motor 13 by controlling the motor drive circuit 24.

The CPU 21 is also connected to the capacitance sensor 14 by means of the capacitance sensor circuit 25 so as to input a capacitance value detected by the capacitance sensor 14. Then, the CPU 21 detects a capacitance state of the capacitance sensor 14, i.e. a capacitance change per unit moving distance. The CPU 21 detects a capacitance changer per unit moving distance of the capacitance sensor 14 at a predetermined timing and changes the threshold value based on the detected result.

According to the first embodiment, the CPU 21 changes the threshold value at predetermined time intervals and writes the threshold value in the memory 26. When the CPU 21 detects that the following vehicle has collided against the present vehicle or is about to collide against the present vehicle, the CPU 21 moves the headrest front portion 12 in a vehicle's forward direction and at the same time reads out the threshold value stored in the memory 26, which is then used for detecting an approach of the head of an occupant by the capacitance sensor 14.

A change of the threshold value performed by the CPU 21 is explained below. The amount of change in capacitance when the capacitance sensor 14 approaches the head of an occupant varies depending on a capacitance state of the capacitance sensor 14. Thus, the CPU 21 periodically detects the capacitance state of the capacitance sensor 14 and specifies the threshold value based on that detected result.

For example, the amount of change in capacitance per unit moving distance is large if a dielectric constant of a space, i.e. a distance L in FIG. 2A, defined between the capacitance sensor 14 and the head of an occupant is high as compared to a case in which the dielectric constant of the space is low under a condition of the same distance by which the headrest front portion 12 moves. Thus, the CPU 21 detects the capacitance change per unit moving distance of the capacitance sensor 14 beforehand so as to change the threshold value based on the detected result. Since the amount of change in capacitance is large when the dielectric constant is high, at that time the threshold value is specified to be high, as compared to a case in which the dielectric constant is low.

Further, according to the first embodiment, the CPU 21 detects a driving voltage of the motor 13 based on a voltage of the power supply unit 16 and changes the threshold value based on the detected result. Since a speed of the motor 13 is high when the driving voltage of the motor 13 is high, the amount of change in capacitance of the capacitance sensor 14 increases.

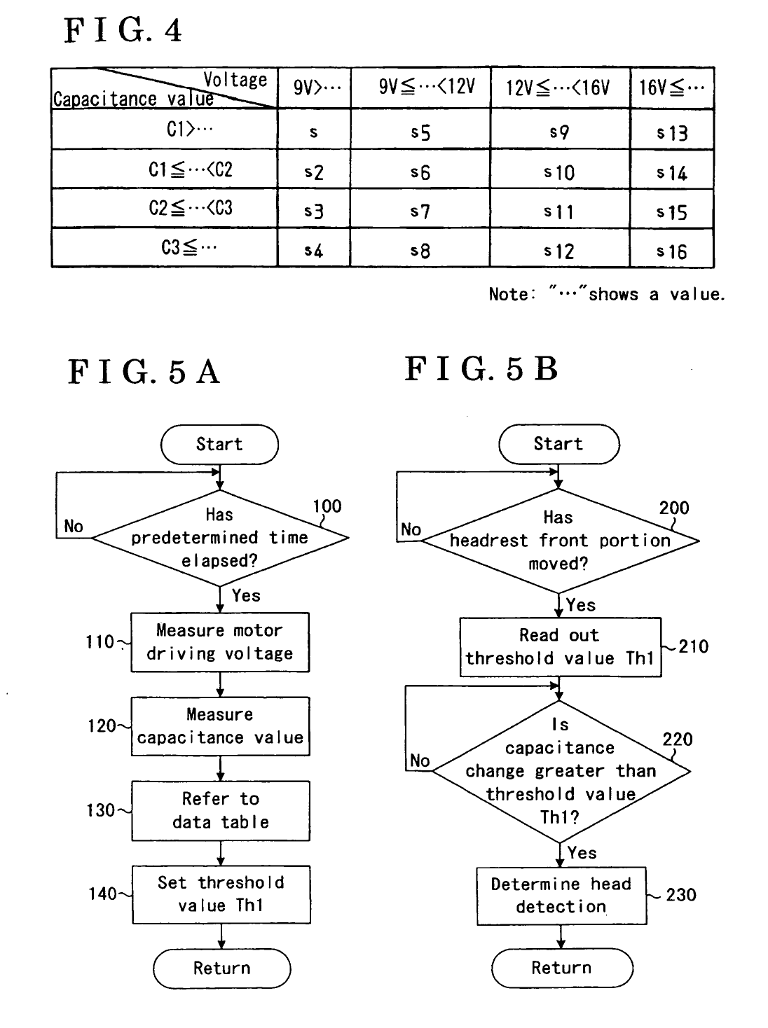

Precisely, the CPU 21 specifies the threshold value based on a data table shown in FIG. 4, for example, which is defined by a detected capacitance value of the capacitance sensor 14 and the driving voltage of the motor 13. In FIG. 4, a relation of s<s2< . . . <s15<s16 is defined. As shown in FIG. 4, the threshold value is specified so as to increase as the capacitance of the capacitance sensor 14 and also the driving voltage of the motor 13 increase.

A process performed by the ECU 20 of the headrest apparatus 10 for a vehicle is explained below. According to the first embodiment, the CPU 21 of the ECU 20 performs a process for changing the threshold value shown in FIG. 5A at predetermined time intervals, and also performs a head detecting process shown in FIG. 5B at a time of an operation of the headrest front portion 12.

As shown in FIG. 5A, the CPU 21 determines whether or not a predetermined time has elapsed in Step 100. When it is determined that the predetermined time has not elapsed, the CPU 21 repeats a process of Step 100. When it is determined that the predetermined time has elapsed, the CPU 21 proceeds to Step 110 in which the driving voltage of the motor 13 is measured.

Next, the CPU 21 proceeds to Step 120 in which the capacitance value of the capacitance sensor 14 is measured. By detecting the capacitance value of the capacitance sensor 14, the capacitance state of the capacitance sensor 14 at that time can be detected.

Then, the CPU 21 proceeds to Step 130 in which the data table shown in FIG. 4 is referred to on the basis of the driving voltage of the motor 13 obtained in Step 110 and the capacitance value of the capacitance sensor 14 obtained in Step 120. Further, the CPU 21 proceeds to Step 140 in which a threshold value Th1 obtained from the data table is specified as the threshold value and then written into the memory 26.

As shown in FIG. 5B, the CPU 21 determines whether or not the headrest front portion 12 has moved in Step 200. When it is determined that the headrest front portion 12 has not moved, the CPU 21 repeats a process of Step 200. When it is determined that the headrest front portion 12 has moved, the CPU 21 proceeds to Step 210 in which the threshold value Th1 stored in the memory 26 is read out.

Next, the CPU 21 proceeds to Step 220 in which it is determined whether or not the amount of change in capacitance detected by the capacitance sensor 14 exceeds the threshold value Th1 along with the movement of the headrest front portion 12.

In the cases where the amount of change does not exceed the threshold value Th1, the CPU 21 repeats a process of Step 220. In the cases where the amount of change is larger than the threshold value Th1, the CPU 21 proceeds to Step 230 in which it is determined that the head of an occupant is detected and then the current process finishes. The movement of the motor 13 towards the fully open position 12B is stopped on the basis of this determination result.

While the ignition switch of a vehicle is in an ON position, the ECU repeats a process from Step 100 to Step 140, and Step 200 to Step 230.

According to the first embodiment, the following effects can be obtained. The threshold value for detecting an approach of the headrest front portion 12 to the head of an occupant is changed on the basis of the capacitance change per unit moving distance of the capacitance sensor 14 (i.e. the capacitance value of the capacitance sensor 14 at that time) at predetermined time intervals. Thus, regardless of the capacitance state of the capacitance sensor 14, a moving distance of the headrest front portion 12 is constantly detected. The approach of the headrest front portion 12 to the head of an occupant can be appropriately detected.

Further, the CPU 21 changes the threshold value at predetermined time intervals before the headrest front portion 12 moves. Thus, the threshold value is not changed at a time of operation of the headrest front portion 12, thereby achieving a prompt detection of the head of an occupant.

Furthermore, the threshold value is specified in response to a moving speed of the headrest front portion 12 since the threshold value is changed on the basis of the driving voltage of the motor 13. Thus, the detection accuracy of the capacitance sensor 14 can be improved.

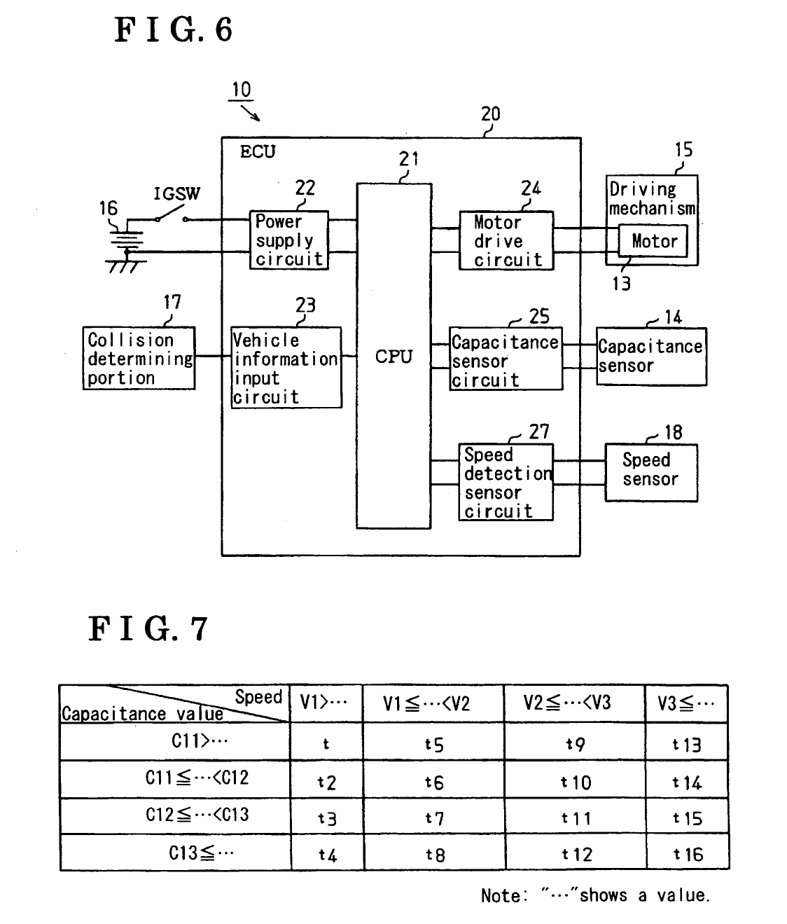

A second embodiment of the present invention is explained with reference to the attached drawings. FIG. 6 is a block diagram of an electric structure of the headrest apparatus 10 of a vehicle. According to the second embodiment, a speed sensor 18 is connected to the ECU 20 in addition to the structure of the headrest apparatus 10 of the first embodiment. The speed sensor 18 is connected to the CPU 21 by means of a speed detection sensor circuit 27 provided in the ECU 20. The speed sensor 18 for detecting a moving speed of the headrest front portion 12 has a known structure of applying a laser beam to a detected object so as to measure a speed thereof from a change in frequency of a reflected wave. With such a structure, the ECU 20 detects the moving speed of the headrest front portion 12.

According to the second embodiment, a method of specifying the threshold value used by the ECU 20 to detect an approach of the headrest front portion 12 to the head of an occupant is different from that of the first embodiment. In the second embodiment, the ECU 20 changes the threshold value when the headrest front portion 12 starts moving towards the fully open position 12B. The ECU 20 detects the capacitance value of the capacitance sensor 14 when the headrest front portion 12 starts moving, and then detects, on the basis of that detected value, the capacitance state, i.e. the capacitance change per unit moving distance of the capacitance sensor 14. The ECU 20 changes the threshold value based on that detected capacitance change per unit moving distance. In addition, the ECU 20 changes the threshold value based on the moving speed of the headrest front portion 12.

Precisely, the CPU 21 specifies the threshold value based on a data table shown in FIG. 7, for example, which is defined by a detected capacitance value of the capacitance sensor 14 and by a moving speed of the headrest front portion 12. In FIG. 7, a relation of t<t2 . . . <t15<t16 is defined. As shown in FIG. 7, the threshold value is specified so as to increase as the capacitance of the capacitance sensor 14 and also the moving speed of the motor 13 increase.

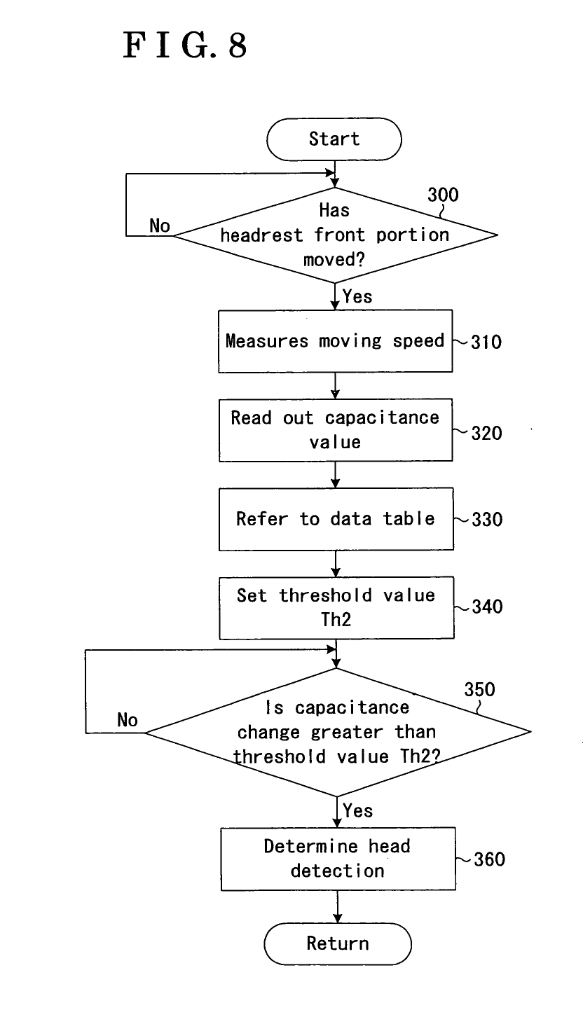

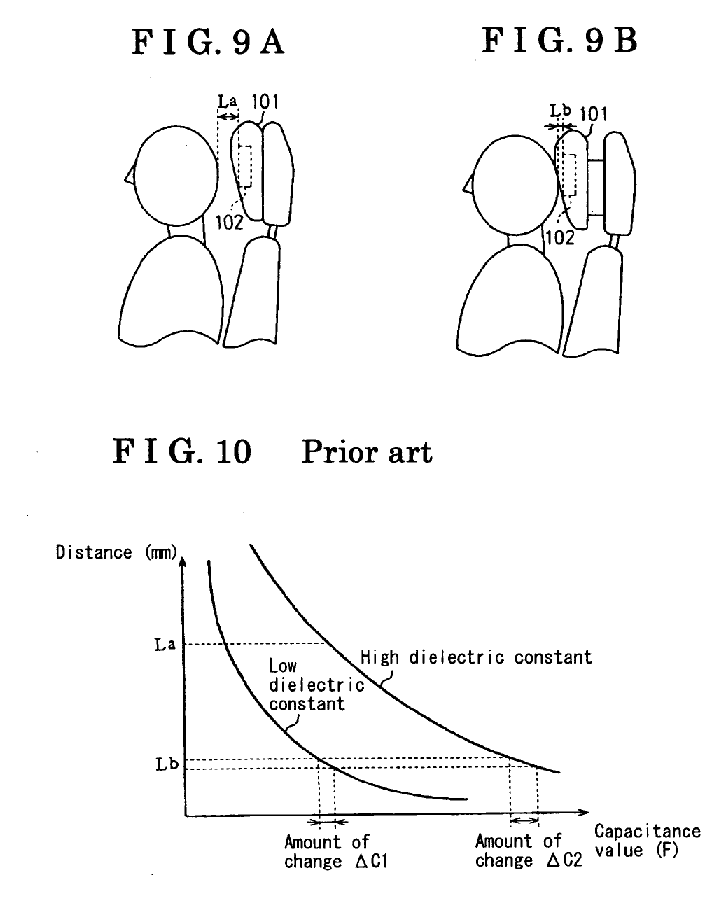

Next, a process performed by the ECU 20 of the headrest apparatus 10 for a vehicle is explained below. As shown in FIG. 8, the CPU 21 of the ECU 20 determines whether or not the headrest front portion 12 has moved in Step 300. When it is determined that the headrest front portion 12 has not moved, the CPU 21 repeats a process of Step 300. When it is determined that the headrest front portion 12 has moved, the CPU 21 proceeds to Step 310 in which a moving speed of the headrest front portion 12 is measured by the speed sensor 18. Then, the CPU 21 proceeds to Step 320 in which the capacitance value of the capacitance sensor 14 is read out. The CPU 21 proceeds to Step 330 in which the data table shown in FIG. 7 is referred to. The CPU 21 then proceeds to Step 340 in which a threshold value Th2 is specified on the basis of the moving speed of the headrest front portion 12 detected in Step 310 and the capacitance value of the capacitance sensor 14 detected in Step 320.

The CPU 21 proceeds to Step 350 in which it is determined whether or not the amount of change in capacitance of the capacitance sensor 14 exceeds the threshold value Th2 along with the movement of the headrest front portion 12.

When the aforementioned amount of change is not greater than the threshold value Th2, the CPU 21 repeats a process of Step 350. When the amount of change is greater than the threshold value Th2, the CPU 21 proceeds to Step 360 in which a head detection is determined, thereby terminating the current process. The headrest front portion 12 is stopped to move towards the fully open position 12B based on the determination results.

While the ignition switch of a vehicle is in an ON position, the ECU 20 repeats a process from Step 300 to Step 360. The second embodiment can obtain the following effects.

The CPU 21 changes the threshold value when the headrest front portion 12 starts moving towards the fully open position 12B. Thus, the threshold value can be specified in response to the capacitance state of the capacitance sensor 14 at that time.

Further, since the threshold value is changed on the basis of the moving speed of the headrest front portion 12, an approach of the head of an occupant can be detected regardless of the moving speed of the headrest front portion 12. The detection accuracy of the capacitance sensor 14 can be improved accordingly.

The aforementioned embodiments can be modified as follows.

According to the first embodiment, the threshold value used for detecting an approach of the headrest front portion 12 to the head of an occupant is changed at predetermined time intervals. According to the second embodiment, the threshold value is changed when the headrest front portion 12 starts moving. However, instead, the timing needed to change the threshold value is not limited to the above. For example, the threshold value can be changed when an angle of the seatback 3 is changed or when it is determined that a posture of an occupant is changed.

According to the aforementioned first embodiment, the threshold value is changed at predetermined time intervals. However, the threshold value can be changed instead, when the headrest front portion 12 starts moving. In this case, the threshold value can be changed either immediately before or after the operation of the headrest front portion 12.

According to the aforementioned first embodiment, the driving voltage of the motor 13 is detected on the basis of a voltage of the power supply unit 16. However, the driving voltage of the motor 13 can be detected by other methods. The driving voltage of the motor 13 can be also directly detected.

The threshold value used for detecting an approach of the headrest front portion 12 to the head of an occupant is specified on the basis of the capacitance state of the capacitance sensor 14 and the driving voltage of the motor 13 according to the aforementioned first embodiment, or on the basis of the capacitance state of the capacitance sensor 14 and the moving speed of the headrest front portion 12 according to the second embodiment. However, in either case, the threshold value can be specified on the basis of the capacitance state of the capacitance sensor 14 only. Even in that case, the moving distance of the headrest front portion 12 can be detected with a high degree of accuracy, and an approach of the headrest front portion 12 to the head of an occupant can be appropriately detected.

According to the aforementioned second embodiment, the moving speed of the headrest front portion 12 is detected by the speed sensor 18. However, the moving speed of the headrest front portion 12 can be detected by other methods. For example, a position detecting sensor for detecting a position of the headrest front portion 12 can be provided so as to detect a speed of the headrest front portion 12 based on a movement of a position of the headrest front portion 12.

According to the aforementioned first and second embodiments, the headrest front portion 12 is brought to move by the motor 13. However, as long as the headrest front portion 12 is movable between the fully closed position 12A and the fully open position 12B, the headrest front portion 12 can be constituted to operate in other manners. For example, the operation of the headrest front portion 12 can be achieved by a spring type or a solenoid type.

According to the aforementioned first and second embodiments, the vehicle seat 1 equipped with the headrest apparatus 10 is applied to a passenger side seat of a vehicle. However, the vehicle seat 1 can be applied to a driver side seat, a rear seat, or the other seat of a vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A headrest apparatus for a vehicle, comprising:
a headrest rear portion supported by a seatback;
a headrest front portion being movable between a fully closed position in which the headrest front portion is closed to the headrest rear portion, and a fully open position in which the headrest front portion is away from the headrest rear portion;
a driving means for moving the headrest front portion;
a capacitance sensor provided at the headrest front portion for detecting a change in capacitance that is caused in response to a distance from a head of an occupant;
a controlling means for controlling the driving means and comparing an amount of change in capacitance detected by the capacitance sensor to a predetermined threshold value when the headrest front portion moves towards the fully open position,
the controlling means determining that the headrest front portion is positioned close to the head when the amount of change in capacitance exceeds the threshold value; and
the controlling means detecting a capacitance change per unit moving distance of the capacitance sensor at a predetermined timing and changing the threshold value based on the detected result.

2. A headrest apparatus for a vehicle according to claim 1, wherein the controlling means changes the threshold value at predetermined time intervals.

3. A headrest apparatus for a vehicle according to claim 1, wherein the controlling means changes the threshold value when the headrest front portion starts moving towards the fully open position.

4. A headrest apparatus for a vehicle according to claim 2, wherein the controlling means changes the threshold value based on a driving voltage of the driving means.

5. A headrest apparatus for a vehicle according to claim 3, wherein the controlling means changes the threshold value based on a moving speed of the headrest front portion.

6. A headrest apparatus for a vehicle according to claim 4, wherein the threshold value is changed on the basis of a data table which is defined by a capacitance value detected by the capacitance sensor and the driving voltage.

7. A headrest apparatus for a vehicle according to claim 6, wherein the threshold value is specified so as to increase as the driving voltage increases.

8. A headrest apparatus for a vehicle according to claim 5, wherein the threshold value is changed on the basis of a data table which is defined by a capacitance value detected by the capacitance sensor and the moving speed of the headrest front portion.

9. A headrest apparatus for a vehicle according to claim 8, wherein the threshold value is specified so as to increase as the moving speed increases.
